(19) United States
(12) Patent Application Publication
(10) Pub. No.: US 2025/0104314 A1
(43) Pub. Date: Mar. 27, 2025

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Masaru KOBAYASHI, Saitama (JP); Kei YAMAJI, Saitama (JP); Toshiki KOBAYASHI, Saitama (JP); Yuya NISHIO, Saitama (JP); Kazuya OKIYAMA, Saitama (JP)

(73) Assignee: FUJIFILM Corporation, Tokyo (JP)

(21) Appl. No.: 18/890,718

(22) Filed: Sep. 19, 2024

(30) Foreign Application Priority Data
Sep. 26, 2023 (JP) 2023-163999

(51) Int. Cl. G06T 11/60

(52) U.S. Cl. CPC G06T 11/60

(57) ABSTRACT

An information processing apparatus including at least one processor, wherein the processor is configured to: acquire an image and related matter information indicating each of a plurality of related matters related to the image; and generate a text based on a relationship between at least two different related matters, based on the image and on the related matter information.

### CROSS-REFERENCE TO RELATED APPLICATIONS

This application claims priority from Japanese Application No. 2023-163999, filed on Sep. 26, 2023, the entire disclosure of which is incorporated herein by reference.

### BACKGROUND

### Technical Field

The disclosed technology relates to an information processing apparatus, an information processing method, and an information processing program.

### Related Art

In the related art, a technology for supporting creation of a photo album using an image owned by a user has been known.

JP2019-149020A, for example, discloses a technology for determining a title of a photo album by analyzing image data used for the photo album, determining a design template based on the title, and assigning the image data and the title to each other using the design template. JP2019-160185A, for example, discloses a technology for generating photo album data using an image that is determined to be appropriate for use in a photo album among pieces of image data received from a user terminal in a case where a voice instruction to produce a photo album is received from a user. JP2020-052947A discloses assisting in a text input of a user by generating a text describing an image and notifying the user of the text.

### SUMMARY

An embodiment according to the disclosed technology provides an information processing apparatus, an information processing method, and an information processing program that can generate an appropriate text related to an image.

A first aspect of the present disclosure is an information processing apparatus comprising at least one processor, in which the processor is configured to acquire an image and related matter information indicating each of a plurality of related matters related to the image, and generate a text based on a relationship between at least two different related matters, based on the image and on the related matter information.

In the first aspect, the processor may be configured to generate the text in a case of setting at least one of the plurality of related matters as an addresser and setting at least another related matter as an addressee.

In the first aspect, the related matter may be at least one subject included in the image or an owner, a creator, an imaging person, or a viewer of the image.

In the first aspect, the subject may be a person, an animal, or an object.

In the first aspect, the processor may be configured to generate the text with reference to a template of the text that is determined in advance in accordance with a combination of the at least two different related matters.

In the first aspect, the processor may be configured to generate the text using a trained model that is trained in advance to take the image and the related matter information as input and output the text.

In the first aspect, the processor may be configured to receive designation of the at least two related matters among the plurality of related matters, and generate the text corresponding to a relationship between the two designated related matters.

In the first aspect, the processor may be configured to generate the text for each combination of the at least two different related matters, and receive selection of at least one of the generated texts for each combination of the related matters.

In the first aspect, the processor may be configured to generate the related matter information based on at least one subject included in the image.

In the first aspect, the processor may be configured to receive input of the related matter information.

In the first aspect, the processor may be configured to acquire accessory information of the image, and generate the related matter information based on the accessory information.

In the first aspect, the processor may be configured to acquire accessory information of the image, and generate the text based on the image, the related matter information, and the accessory information.

In the first aspect, the processor may be configured to acquire a plurality of images to which the same related matter is related, and generate the text corresponding to a comparison among the plurality of images.

A second aspect of the present disclosure is an information processing method of executing a process via a computer, the process comprising acquiring an image and related matter information indicating each of a plurality of related matters related to the image, and generating a text based on a relationship between at least two different related matters, based on the image and on the related matter information.

A third aspect of the present disclosure is an information processing program causing a computer to execute a process comprising acquiring an image and related matter information indicating each of a plurality of related matters related to the image, and generating a text based on a relationship between at least two different related matters, based on the image and on the related matter information.

### BRIEF DESCRIPTION OF THE DRAWINGS

FIG. 1 is a schematic diagram illustrating an example of a configuration of an information processing system.

FIG. 2 is a diagram illustrating an example of a photo album including an image and a text.

FIG. 3 is a block diagram illustrating an example of a hardware configuration of an information processing apparatus.

FIG. 4 is a block diagram illustrating an example of a functional configuration of the information processing apparatus.

FIG. 5 is a diagram illustrating examples of a template of a text.

FIG. 6 is a diagram illustrating an example of a photo album including an image and a text.

FIG. 7 is a diagram illustrating an example of a screen for selecting a text.

FIG. 8 is a diagram illustrating an example of a screen for generating a text.

FIG. 9 is a flowchart illustrating an example of a flow of information processing.

### DETAILED DESCRIPTION

Hereinafter, an embodiment of the present disclosure will be described in detail with reference to the drawings.

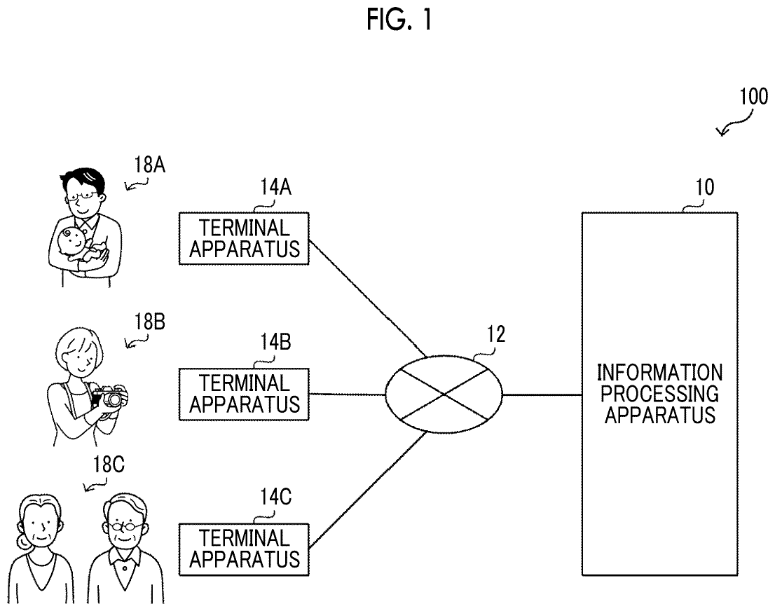

First, an information processing system 100 to which an information processing apparatus 10 according to the present embodiment is applied will be described with reference to FIG. 1. FIG. 1 is a diagram illustrating a schematic configuration of the information processing system 100. As illustrated in FIG. 1, the information processing system 100 comprises the information processing apparatus 10 and a plurality of terminal apparatuses 14A to 14C owned by a plurality of users 18A to 18C, respectively. Hereinafter, each of the users 18A to 18C will be simply referred to as a “user 18” unless distinguished, and each of the terminal apparatuses 14A to 14C will be simply referred to as a “terminal apparatus 14” unless distinguished.

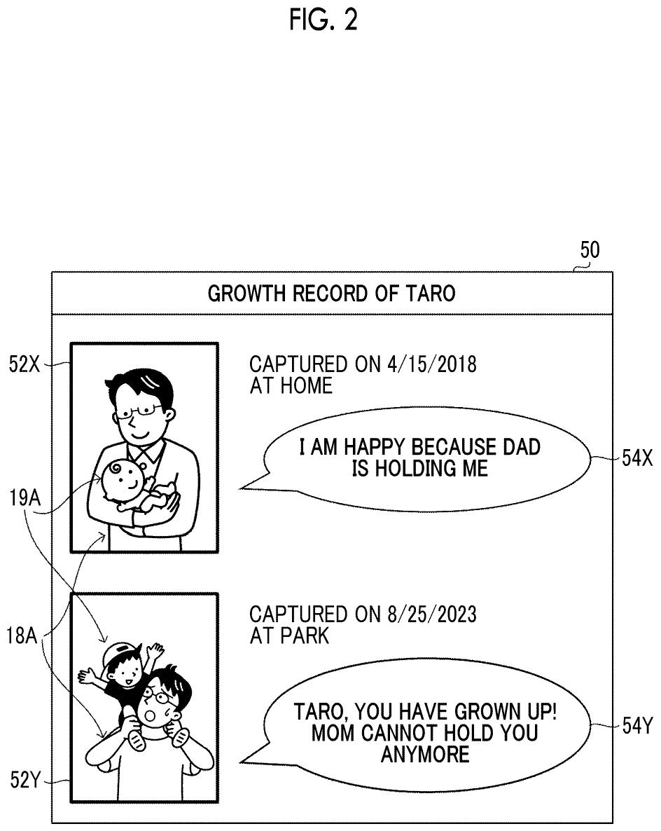

The terminal apparatus 14 is an apparatus having a camera function, an image playback and display function, an image transmission and reception function, and the like. The camera function is a function of obtaining an image 52 (refer to FIG. 2) of a subject by forming an image of subject light acquired from a lens on an imaging element such as a complementary metal-oxide-semiconductor (CMOS) image sensor. For example, a smartphone, a tablet terminal, a personal computer, a digital camera, and the like can be applied as the terminal apparatus 14, as appropriate. The terminal apparatus 14 is not limited to a configuration of one apparatus and may be composed of a plurality of apparatuses, for example, a combination of a digital camera and a personal computer.

The terminal apparatus 14 and the information processing apparatus 10 are connected to be capable of communicating with each other through a wired or wireless network 12. The network 12 is, for example, a wide area network (WAN) such as the Internet or a public communication network. The terminal apparatus 14 transmits (uploads) the image 52 to the information processing apparatus 10. The terminal apparatus 14 receives (downloads) a photo album 50 from the information processing apparatus 10.

The information processing apparatus 10 creates the photo album 50 using the image 52 acquired by the terminal apparatus 14 and transmits the created photo album 50 to the terminal apparatus 14. Specifically, the information processing apparatus 10 creates the photo album 50 by generating a text 54 appropriate for the image 52 received from the terminal apparatus 14 and attaching the text 54 to the corresponding image 52.

The photo album 50 is, for example, a collection of a plurality of images 52 based on themes of various events such as a school event, a trip, and a wedding ceremony and a growth record and the like. The text 54 about the subject, an imaging person, an imaging date and time, an imaging place, an imaging situation, and the like of the image 52 may be attached to the image 52.

FIG. 2 illustrates an example of the photo album 50. In the example in FIG. 2, the photo album 50 titled “growth record of Taro” includes two images 52X and 52Y, and texts 54X and 54Y are attached to the images 52X and 52Y, respectively. Each of the images 52X and 52Y includes the user 18A and a child 19A as the subject. In the present example, the child 19A is a child named “Taro”, and the user 18A is a father of Taro. The user 18B who is an imaging person of the images 52X and 52Y is a mother of Taro, and the user 18C who is a viewer of the photo album 50 is a grandparent of Taro.

The user 18 captures the image 52 using the camera function or views the photo album 50 using the image playback and display function of the terminal apparatus 14. According to the information processing system 100, the user 18A who is the subject of the image 52, the user 18B who is the imaging person, the user 18C who is the viewer, and the like can view the photo album 50 at their respective preferred times. One photo album 50 can be formed with a collection of images captured by each of the users 18A to 18C, or each of the users 18A to 18C can edit one photo album 50.

A note such as a thought, a request, and an instruction addressed from one related matter to another related matter of the image 52 may be used as the text 54 attached to the image 52 in the photo album 50. For example, the text 54X of “I am happy because dad is holding me” illustrated in FIG. 2 assumes a thought addressed from the child 19A (Taro) who is the subject to the user 18A (father) who is another subject. For example, the text 54Y of “Taro, you have grown up! Mom cannot hold you anymore” illustrated in FIG. 2 assumes a thought addressed from the user 18B (mother) who is the imaging person to the child 19A (Taro) who is the subject.

The image 52 may be made more impressive by attaching the text 54 such as the texts 54X and 54Y addressed from one related matter to another related matter to the image 52. Therefore, the information processing apparatus 10 according to the present embodiment generates the text 54 based on a relationship between at least two different related matters related to the image 52. Hereinafter, details of the information processing apparatus 10 will be described.

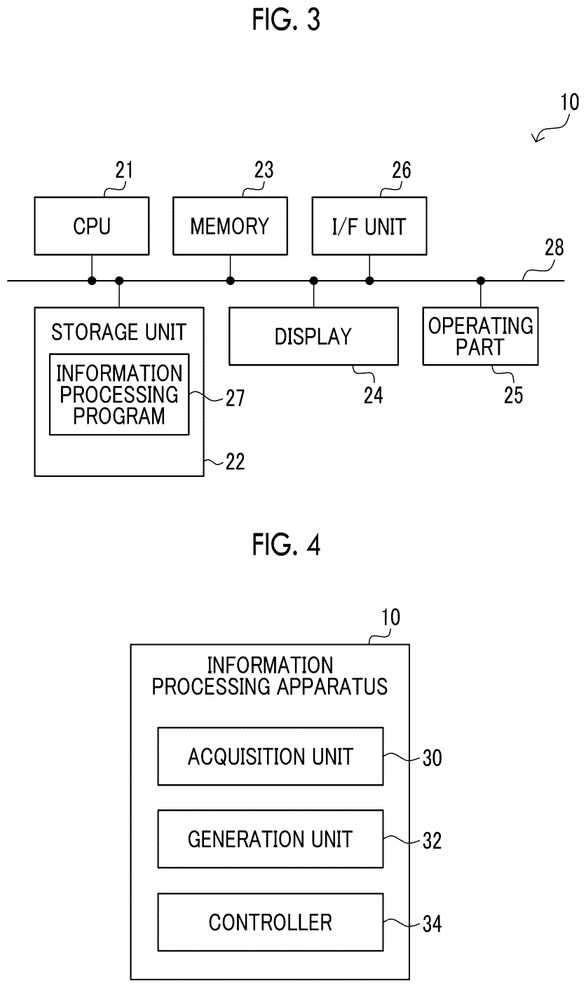

First, an example of a hardware configuration of the information processing apparatus 10 will be described with reference to FIG. 3. As illustrated in FIG. 3, the information processing apparatus 10 includes a central processing unit (CPU) 21, a non-volatile storage unit 22, and a memory 23 as a temporary storage region. The information processing apparatus 10 also includes a display 24 such as a liquid crystal display, an operating part 25 such as a touch panel, a keyboard, and a mouse, and an interface (I/F) unit 26. The I/F unit 26 performs wired or wireless communication with the terminal apparatus 14 and other external apparatuses and the like. The CPU 21, the storage unit 22, the memory 23, the display 24, the operating part 25, and the I/F unit 26 are connected to be capable of exchanging various types of information with each outer through a bus 28 such as a system bus and a control bus.

The storage unit 22, for example, is implemented by a storage medium such as a hard disk drive (HDD), a solid state drive (SSD), and a flash memory. An information processing program 27 in the information processing apparatus 10 is stored in the storage unit 22. The CPU 21 reads out and loads the information processing program 27 into the memory 23 from the storage unit 22 and executes the loaded information processing program 27. The CPU 21 is an example of a processor of the present disclosure. For example, a server computer, a personal computer, a smartphone, a tablet terminal, a wearable terminal, and the like can be applied as the information processing apparatus 10, as appropriate.

Next, an example of a functional configuration of the information processing apparatus 10 will be described with reference to FIG. 4. As illustrated in FIG. 4, the information processing apparatus 10 includes an acquisition unit 30, a generation unit 32, and a controller 34. By executing the information processing program 27 via the CPU 21, the CPU 21 functions as each functional unit including the acquisition unit 30, the generation unit 32, and the controller 34.

The acquisition unit 30 acquires at least one image 52 from the terminal apparatus 14. The image 52 is, for example, an image (that is, a photograph) captured using the camera function of the terminal apparatus 14. For example, accessory information such as the imaging date and time, a position, an azimuth, an identification ID of the imaging person, and an identification ID of an imaging apparatus may be assigned to the image 52. Examples of a format of the accessory information include an exchangeable image file format (EXIF).

The acquisition unit 30 acquires related matter information indicating each of a plurality of related matters related to the acquired image 52. A related matter is, for example, at least one subject included in the image 52 or an owner, a creator, the imaging person, or the viewer of the image 52. That is, the related matter information is information for specifying the subject included in the image 52 or the owner, the creator, the imaging person, or the viewer of the image 52.

Specifically, the acquisition unit 30 may generate the related matter information based on the subject included in the acquired image 52. For example, the acquisition unit 30 may specify the subject captured in the image 52 by analyzing the image 52 and generate the related matter information indicating the specified subject. For example, well-known techniques such as a technique using a cascade classifier and a technique using pattern matching can be applied as a technique for analyzing the image 52, as appropriate.

The acquisition unit 30 may receive input of the related matter information provided by the user 18. For example, the acquisition unit 30 may control the display 24 or a display of the terminal apparatus 14 to display a screen for asking the related matter of the image 52 and acquire information input on the screen as the related matter information.

The acquisition unit 30 may acquire the accessory information of the image 52 and generate the related matter information based on the accessory information. As described above, the accessory information of the image 52 may include the identification ID of the imaging person. In this case, the acquisition unit 30 may specify information indicating the imaging person specified based on the identification ID of the imaging person included in the accessory information as the related matter information.

The acquisition unit 30 may acquire information about the user 18 who is the owner of the terminal apparatus 14 from the terminal apparatus 14 and generate the related matter information based on the information about the user 18. The user 18 may correspond to at least one of the owner, the creator, the imaging person, or the viewer of the image 52. The information about the user 18 is information indicating, for example, an identification ID, a name, an age, a sex, and a family structure of the user 18 set in advance in the terminal apparatus 14.

The subject as the related matter indicated by the related matter information is not limited to a person and may be an animal or an object. The object corresponds to various artificial objects and natural objects, and examples of the object include a tool, a toy, a machine, a building, a plant, and a landform such as a mountain, a sea, and a river.

The related matter indicated by the related matter information may be an individual object or a set. For example, the related matter information may indicate a set consisting of a plurality of persons, animals, or objects such as “parents and a child”, “grandparents”, “all school students”, “teenage girls”, and “three dogs”.

A degree of concretization of the related matter indicated by the related matter information is not limited to a particular degree. Information indicating an attribute of the related matter, information for identifying the individual object, and the like can be applied, as appropriate. For example, while different expressions such as an “animal”, a “dog”, a “pet”, and a “Woofer” (a nickname of a pet dog) are considered for information indicating the same related matter, any of the expressions may be used as the related matter information of the present disclosure.

The generation unit 32 generates the text 54 based on the relationship between at least two different related matters, based on the image 52 and the related matter information acquired by the acquisition unit 30. Specifically, the generation unit 32 generates the text 54 in a case of setting at least one of the plurality of related matters related to the image 52 as an addresser and setting at least another related matter as an addressee. That is, the text 54 is a note such as a thought, a request, and an instruction addressed from one related matter to another related matter of the image 52.

The text 54 is generated in accordance with content of the image 52. For example, the generation unit 32 may analyze the subject included in the image 52 and a situation and the like of the subject and generate the text 54 corresponding to an analysis result. For example, well-known techniques such as a technique using a cascade classifier and a technique using pattern matching can be applied as a technique for analyzing the image 52, as appropriate.

In the example in FIG. 2, the acquisition unit 30 acquires the related matter information indicating each of the child 19A (Taro) and the user 18A (father) who are the subjects, the user 18B (mother) who is the imaging person, and the user 18C (grandparent) who is the viewer as related matters of the image 52X. The generation unit 32 analyzes a situation such as “father is holding Taro”, “Taro is smiling”, and “father is smiling” for the image 52X. The generation unit 32 generates the text 54X of “I am happy because dad is holding me” by assuming a thought addressed from the child 19A (Taro) to the user 18A (father) in this situation.

A plurality of related matters may be set as the addresser and the addressee of the generated text 54. For example, the text 54 such as “both of dad and Taro look happy” in which a plurality of persons are set as the addressee may be generated. While the text 54 may seem to be a mere description or depiction of the image 52, the text 54 is a text indicating an impression of the subject seen by the viewer, that is, a text addressed from the viewer to the subject, and is included in an example of a text of the present disclosure.

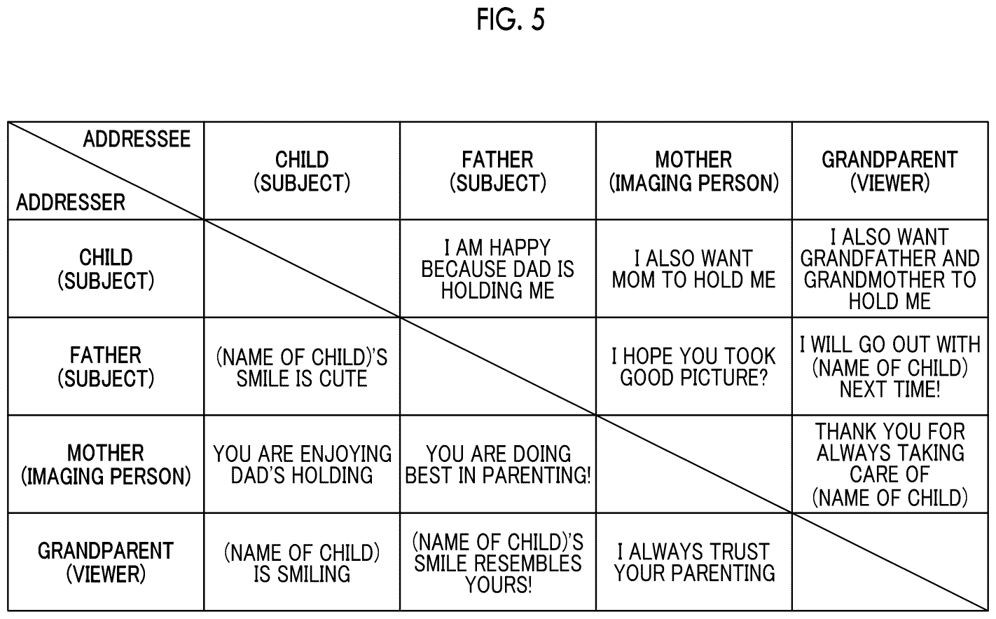

Well-known methods can be applied as a method of generating the text 54, as appropriate. For example, the generation unit 32 may generate the text 54 with reference to a template of the text 54 that is determined in advance in accordance with a combination of at least two different related matters. FIG. 5 illustrates examples of the template. FIG. 5 illustrates the template of the text 54 that may be attached to the image 52 in a situation where a child and a father are the subjects, a mother is the imaging person, a grandparent is the viewer, and the father is holding the child. Such a template may be prepared in advance for each related matter and each situation and may be stored in the storage unit 22 and an external database server or the like.

The generation unit 32 may acquire the text 54 attached to the image 52 with reference to an appropriate template based on the analysis result and the related matter information of the image 52. A more appropriate text 54 may be generated by changing at least a part of the text 54 acquired from the template. For example, the generation unit 32 may substitute a part “(name of the child)” in the template in FIG. 5 with “Taro” based on the related matter information.

The generation unit 32 may generate the text 54 using, for example, a trained model that is trained in advance to take an image and related matter information as input and output a text. This trained model is, for example, a machine learning model that is trained using learning data including a combination of an image, related matter information of the image, and a text attached to the image. Well-known models such as a convolutional neural network (CNN) and a recurrent neural network (RNN) can be applied as the machine learning model, as appropriate. In a case where there are a plurality of images 52 to which the same related matter is related, the text 54 added to one image may be generated in accordance with content of another image. For example, the generation unit 32 may acquire the plurality of images 52 to which the same related matter is related and generate the text 54 corresponding to a comparison among the plurality of images 52. The text 54 corresponding to the comparison may indicate, for example, a change in an appearance and a form of the subject over time. In the example in FIG. 2, the generation unit 32 generates the text 54Y including a sentence of “Taro, you have grown up!” by comparing the image 52X and the image 52Y each including the child 19A (Taro) as the subject with each other.

The generation unit 32 may generate the text 54 based on the image 52, the related matter information, and the accessory information. As described above, the accessory information of the image 52 may include information such as the imaging date and time, the position, and the azimuth. The generation unit 32 may generate, for example, the text 54 of “amusement park in December, it was cold but fun” using the imaging date and time and positional information attached to the image 52.

As described above, an animal or an object can also be applied as the related matter. For example, the generation unit 32 may generate the text 54 indicating a thought in a case where an animal or an object is personified as the addresser. For example, the generation unit 32 may generate the text 54 indicating a thought from a viewpoint of the owner, the creator, the imaging person, or the viewer of the image 52 in a case where an animal or an object is set as the addressee.

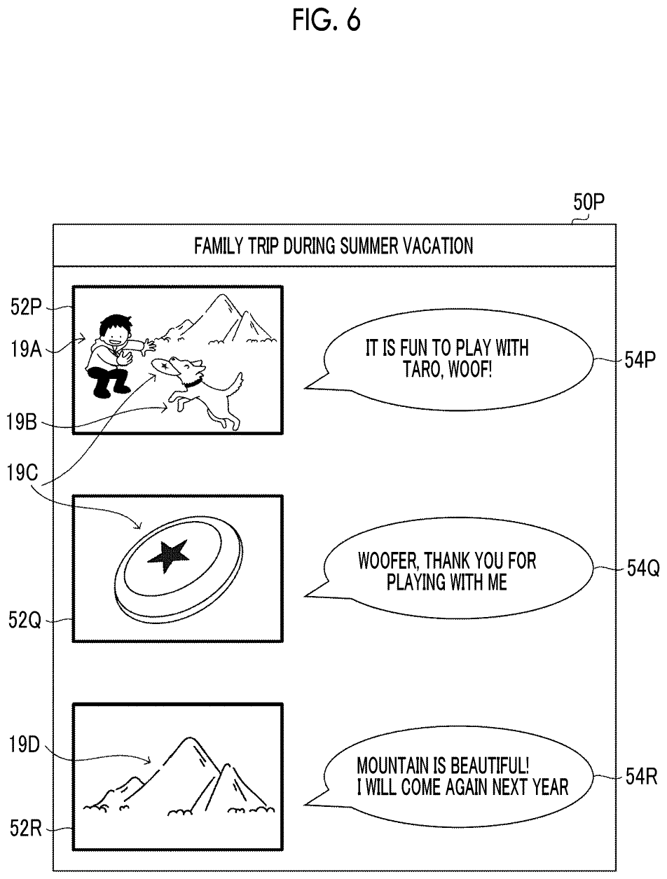

FIG. 6 illustrates an example of a photo album 50P including texts 54P to 54R in a case where at least one related matter is an animal or an object. In FIG. 6, the text 54P attached to an image 52P assumes a thought addressed from a dog 19B that is the subject to the child 19A (Taro) that is another subject. The text 54Q attached to an image 52Q assumes a thought addressed from a flying disc 19C that is the subject to the dog 19B that is another subject, and is generated in accordance with content of another image 52P indicating that “the dog 19B is playing with the flying disc 19C”. In the present example, the dog 19B is nicknamed “Woofer”. The text 54R attached to an image 52R assumes a thought addressed from the imaging person (not illustrated) to a mountain that is the subject.

The generation unit 32 may generate the text 54 for each combination of at least two different related matters for the image 52 and receive selection of at least one of the generated texts 54 for each combination of the related matters. That is, the generation unit 32 may generate a plurality of candidates of the text 54 attached to the image 52 by varying the addresser and the addressee and cause the user 18 to select at least one of the plurality of candidates. The generation unit 32 may not generate the text 54 for all combinations of the related matters of the image 52 and may generate the candidates of the text 54 for at least a part of the combinations.

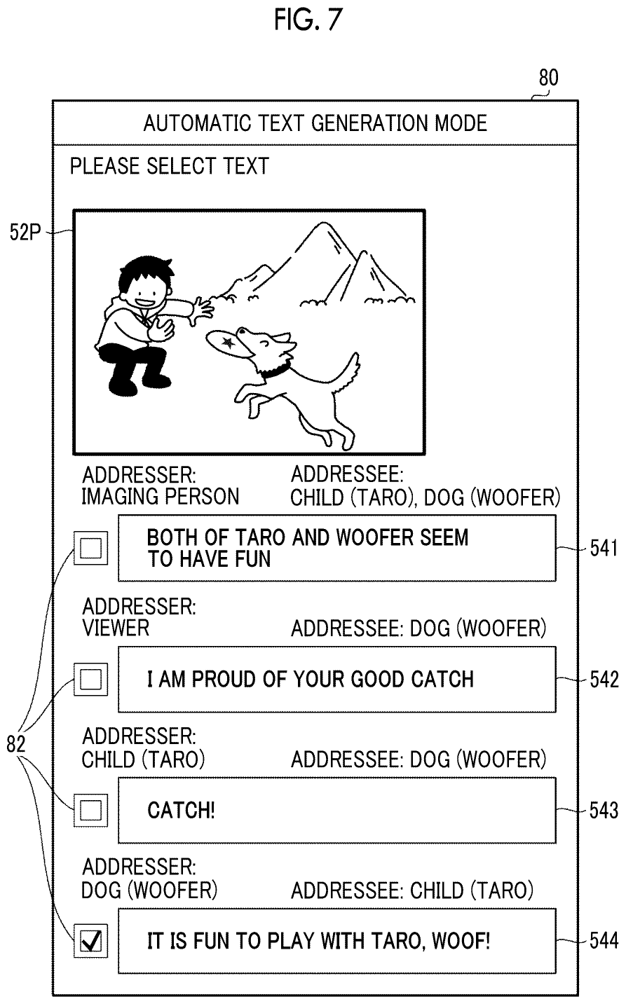

FIG. 7 illustrates an example of a screen 80 for selecting the text 54P attached to the image 52P. The screen 80 includes text candidates 541 to 544 generated for each of four combinations of related matters of the image 52P. The text candidate 541 is a text for a combination of the addresser as the imaging person and the addressee as the child 19A (Taro) and the dog 19B (Woofer) that are the subjects. The text candidate 542 is a text for a combination of the addresser as the viewer and the addressee as the dog 19B (Woofer) that is the subject. The text candidate 543 is a text for a combination of the addresser as the child 19A (Taro) that is the subject and the addressee as the dog 19B (Woofer) that is the subject. The text candidate 544 is a text for a combination of the addresser as the dog 19B (Woofer) that is the subject and the addressee as the child 19A (Taro) that is the subject.

The screen 80 also includes checkboxes 82 for selecting at least one of the text candidates 541 to 544. The controller 34 performs a control of displaying the screen 80 on the display 24 or on the display of the terminal apparatus 14. The user 18 checks the screen 80 and selects at least one text candidate desired to be added to the image 52P from the text candidates 541 to 544 using the checkboxes 82. The generation unit 32 determines at least one text candidate selected from the text candidates 541 to 544 as the text 54P attached to the image 52P. FIG. 7 illustrates a case where the text candidate 544 is selected.

The generation unit 32 may receive designation of at least two related matters among the plurality of related matters for the image 52 and generate the text 54 corresponding to a relationship between the two designated related matters. That is, the generation unit 32 may cause the user 18 to designate the addresser and the addressee of the text 54 before generating the text 54.

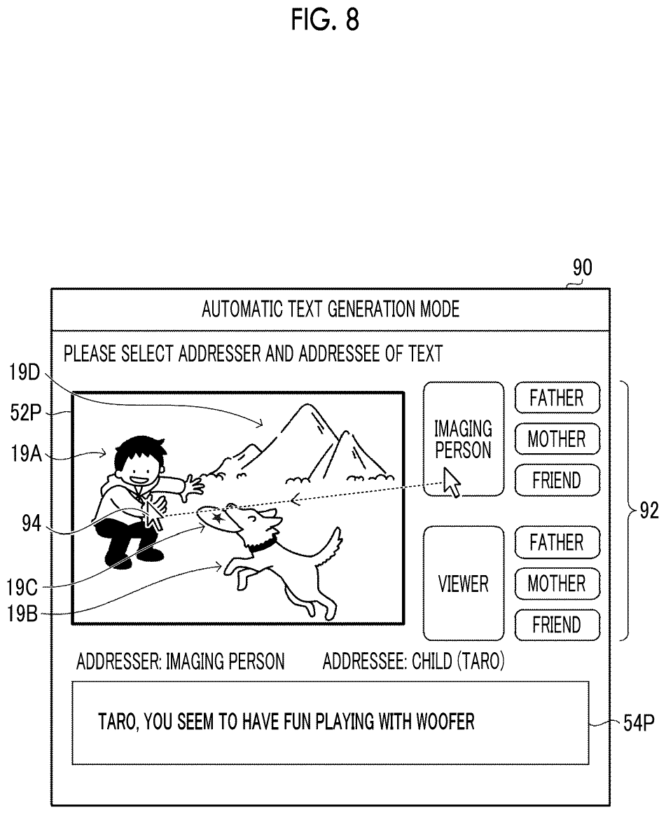

FIG. 8 illustrates an example of a screen 90 for designating a related matter to be used for generating the text 54. The screen 90 includes the image 52P and buttons 92 indicating each of the imaging person and the viewer as the related matter not included in the image 52P. Each of the buttons 92 indicating the imaging person and the viewer is provided with a button for designating a specific attribute (a “father”, a “mother”, and a “friend”) and a button not for designating an attribute (the “imaging person” and the “viewer”). The image 52P includes the child 19A (Taro), the dog 19B (Woofer), the flying disc 19C, and a mountain 19D as the subject.

The controller 34 performs a control of displaying the screen 90 on the display 24 or on the display of the terminal apparatus 14. The user 18 checks the screen 90 and designates the addresser and the addressee of the text 54 attached to the image 52P. The generation unit 32 generates the text 54 corresponding to the addresser and the addressee designated by the user 18.

For example, the user 18 performs a drag-and-drop operation with a mouse pointer 94 from the button 92 or the related matter in the image 52P desired to be set as the addresser to the button 92 or the related matter in the image 52P desired to be set as the addressee. FIG. 8 illustrates the text 54P generated in a case where the button 92 of the “imaging person” is designated as the addresser and the “child 19A (Taro)” in the image 52P is designated as the addressee.

The controller 34 stores the text 54 generated by the generation unit 32 in the storage unit 22 and the external database server or the like as the photo album 50 in association with the image 52. In a case where a request to view the photo album 50 is made from the terminal apparatus 14, the controller 34 transmits the photo album 50 to the terminal apparatus 14.

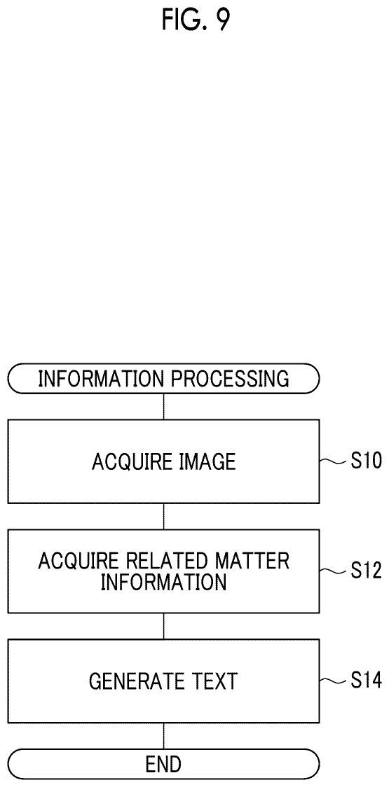

Next, an action of the information processing apparatus 10 according to the present embodiment will be described with reference to FIG. 9. In the information processing apparatus 10, information processing illustrated in FIG. 9 is executed by executing the information processing program 27 via the CPU 21. For example, the information processing is executed in a case where an instruction to start execution is provided by the user 18.

In step S10, the acquisition unit 30 acquires at least one image 52 from the terminal apparatus 14. In step S12, the acquisition unit 30 acquires the related matter information indicating each of the plurality of related matters related to the image 52 acquired in step S10. In step S14, the generation unit 32 generates the text 54 based on the relationship between at least two different related matters, based on the image 52 acquired in step S10 and on the related matter information acquired in step S12. In a case where step S12 is completed, the present information processing is finished.

As described above, the information processing apparatus 10 according to an aspect of the present disclosure comprises at least one processor, in which the processor acquires the image 52 and the related matter information indicating each of the plurality of related matters related to the image 52, and generates the text 54 based on the image 52 and on the relationship between at least two different related matters, based on the related matter information.

That is, according to the information processing apparatus 10, an appropriate text 54 related to the image, for example, a note such as a thought, a request, an instruction, and the like addressed from one related matter to another related matter of the image 52, can be generated. Accordingly, the text 54 can be added to the image 52, and the image 52 can be made more impressive.

While a form of applying the disclosed technology to creation of the photo album 50 has been described in the embodiment, the present disclosure is not limited to this. The disclosed technology can be applied to creation of various articles including a combination of the image 52 and the text 54. For example, the disclosed technology may be applied to creation of an album, a photo book, a photo register, a postcard, and a message card. Means for implementing these is not limited to electronic data and may be, for example, printing on a medium such as paper and a resin film.

While the image 52 that is in a form of a photograph captured using the camera function of the terminal apparatus 14 has been described in the embodiment, the disclosed technology is not limited to this. For example, image data generated by computer graphics (CG) may be used as the image 52. For example, a painting may be used as the subject. In this case, the image 52 of the painting may be obtained by reading a paper surface on which the painting is drawn using a scanner. In a case where the image 52 includes CG or a painting, the related matter information may indicate a person, an animal, or an object drawn by the CG or the painting. For example, in a case where the image 52 is one frame of an animation work, the acquisition unit 30 may acquire the related matter information related to a character of the animation work, and the generation unit 32 may generate the text 54 that assumes a thought from one character to another character.

In each embodiment, for example, various processors illustrated below can be used as a hardware structure of a processing unit that executes various types of processing, such as the acquisition unit 30, the generation unit 32, and the controller 34. The various processors include, in addition to a CPU that is a general-purpose processor functioning as various processing units by executing software (program) as described above, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to perform specific processing, and the like.

One processing unit may be composed of one of the various processors or may be composed of a combination of two or more processors of the same type or different types (for example, a combination of a plurality of FPGAs or a combination of a CPU and an FPGA). A plurality of processing units may be composed of one processor.

Examples of the plurality of processing units composed of one processor include, first, as represented by a computer such as a client and a server, a form of one processor composed of a combination of one or more CPUs and software, in which the processor functions as the plurality of processing units. Second, as represented by a system on chip (SoC) or the like, a form of using a processor that implements functions of the entire system including the plurality of processing units in one integrated circuit (IC) chip is included. Accordingly, various processing units are configured using one or more of the various processors as the hardware structure.

More specifically, an electric circuit (circuitry) in which circuit elements such as semiconductor elements are combined can be used as the hardware structure of the various processors.

While an aspect in which the information processing program 27 in the information processing apparatus 10 is stored in advance in the storage unit 22 has been described in the embodiment, the disclosed technology is not limited to this. The information processing program 27 may be provided in a form of a recording on a recording medium such as a compact disc read only memory (CD-ROM), a digital versatile disc read only memory (DVD-ROM), and a universal serial bus (USB) memory. The information processing program 27 may also be in a form of a download from an external apparatus through a network. In addition to the program, the disclosed technology also applies to a non-transitory storage medium that stores the program.

In the disclosed technology, the embodiment and the examples can be combined, as appropriate. Above described content and illustrated content are detailed description for parts according to the disclosed technology and are merely an example of the disclosed technology. For example, description related to the above configurations, functions, actions, and effects is description related to examples of configurations, functions, actions, and effects of the parts according to the disclosed technology. Thus, it is possible to remove unnecessary parts, add new elements, or replace parts in the above described contents and the illustrated contents without departing from the gist of the disclosed technology.

The following appendices are further disclosed with respect to the embodiment.

### Appendix 1

An information processing apparatus comprising at least one processor, in which the processor is configured to acquire an image and related matter information indicating each of a plurality of related matters related to the image, and generate a text based on a relationship between at least two different related matters, based on the image and on the related matter information.

### Appendix 2

The information processing apparatus according to Appendix 1, in which the processor is configured to generate the text in a case of setting at least one of the plurality of related matters as an addresser and setting at least another related matter as an addressee.

### Appendix 3

The information processing apparatus according to Appendix 1 or 2, in which the related matter is at least one subject included in the image or an owner, a creator, an imaging person, or a viewer of the image.

### Appendix 4

The information processing apparatus according to Appendix 3, in which the subject is a person, an animal, or an object.

### Appendix 5

The information processing apparatus according to any one of Appendices 1 to 4, in which the processor is configured to generate the text with reference to a template of the text that is determined in advance in accordance with a combination of the at least two different related matters.

### Appendix 6

The information processing apparatus according to any one of Appendices 1 to 5, in which the processor is configured to generate the text using a trained model that is trained in advance to take the image and the related matter information as input and output the text.

### Appendix 7

The information processing apparatus according to any one of Appendices 1 to 6, in which the processor is configured to receive designation of the at least two related matters among the plurality of related matters, and generate the text corresponding to a relationship between the two designated related matters.

### Appendix 8

The information processing apparatus according to any one of Appendices 1 to 7, in which the processor is configured to generate the text for each combination of the at least two different related matters, and receive selection of at least one of the generated texts for each combination of the related matters.

### Appendix 9

The information processing apparatus according to any one of Appendices 1 to 8, in which the processor is configured to generate the related matter information based on at least one subject included in the image.

### Appendix 10

The information processing apparatus according to any one of Appendices 1 to 9, in which the processor is configured to receive input of the related matter information.

### Appendix 11

The information processing apparatus according to any one of Appendices 1 to 10, in which the processor is configured to acquire accessory information of the image, and generate the related matter information based on the accessory information.

### Appendix 12

The information processing apparatus according to any one of Appendices 1 to 11, in which the processor is configured to acquire accessory information of the image, and generate the text based on the image, the related matter information, and the accessory information.

### Appendix 13

The information processing apparatus according to any one of Appendices 1 to 12, in which the processor is configured to acquire a plurality of images to which the same related matter is related, and generate the text corresponding to a comparison among the plurality of images.

### Appendix 14

An information processing method of executing a process via a computer, the process comprising acquiring an image and related matter information indicating each of a plurality of related matters related to the image, and generating a text based on a relationship between at least two different related matters, based on the image and on the related matter information.

### Appendix 15

An information processing program causing a computer to execute a process comprising acquiring an image and related matter information indicating each of a plurality of related matters related to the image, and generating a text based on a relationship between at least two different related matters, based on the image and on the related matter information.

What is claimed is:

1. An information processing apparatus comprising at least one processor, wherein the processor is configured to:
acquire an image and related matter information indicating each of a plurality of related matters related to the image; and
generate a text based on a relationship between at least two different related matters, based on the image and on the related matter information.

2. The information processing apparatus according to claim 1, wherein the processor is configured to generate the text in a case of setting at least one of the plurality of related matters as an addresser and setting at least another related matter as an addressee.

3. The information processing apparatus according to claim 1, wherein the related matter is at least one subject included in the image or an owner, a creator, an imaging person, or a viewer of the image.

4. The information processing apparatus according to claim 3, wherein the subject is a person, an animal, or an object.

5. The information processing apparatus according to claim 1, wherein the processor is configured to generate the text with reference to a template of the text that is determined in advance in accordance with a combination of the at least two different related matters.

6. The information processing apparatus according to claim 1, wherein the processor is configured to generate the text using a trained model that is trained in advance to take the image and the related matter information as input and output the text.

7. The information processing apparatus according to claim 1, wherein the processor is configured to:
receive designation of the at least two related matters among the plurality of related matters; and
generate the text corresponding to a relationship between the two designated related matters.

8. The information processing apparatus according to claim 1, wherein the processor is configured to:
generate the text for each combination of the at least two different related matters; and
receive selection of at least one of the generated texts for each combination of the related matters.

9. The information processing apparatus according to claim 1, wherein the processor is configured to generate the related matter information based on at least one subject included in the image.

10. The information processing apparatus according to claim 1, wherein the processor is configured to receive input of the related matter information.

11. The information processing apparatus according to claim 1, wherein the processor is configured to:
acquire accessory information of the image; and
generate the related matter information based on the accessory information.

12. The information processing apparatus according to claim 1, wherein the processor is configured to:
acquire accessory information of the image; and
generate the text based on the image, the related matter information, and the accessory information.

13. The information processing apparatus according to claim 1, wherein the processor is configured to:
acquire a plurality of images to which the same related matter is related; and
generate the text corresponding to a comparison among the plurality of images.

14. An information processing method of executing a process via a computer, the process comprising:
acquiring an image and related matter information indicating each of a plurality of related matters related to the image; and
generating a text based on a relationship between at least two different related matters, based on the image and on the related matter information.

15. A non-transitory computer-readable storage medium storing an information processing program causing a computer to execute a process comprising:
acquiring an image and related matter information indicating each of a plurality of related matters related to the image; and
generating a text based on a relationship between at least two different related matters, based on the image and on the related matter information.
